(19) United States
(12) Patent Application Publication
(10) Pub. No.: US 2012/0075205 A1
(43) Pub. Date: Mar. 29, 2012

(54) TOUCH INPUT DEVICE AND POWER SAVING METHOD THEREOF

(75) Inventors: YU-REN HUANG, Tu-Cheng (TW); PIN-CHUNG WU, Tu-Cheng (TW); MIN-LEE CHI, Tu-Cheng (TW); TE-SHENG WANG, Tu-Cheng (TW); CHIEN-JUNG LIEN, Tu-Cheng (TW); TAO-HSIN LIU, Tu-Cheng (TW)

(73) Assignee: HON HAI PRECISION INDUSTRY CO., LTD., Tu-Cheng (TW)

(21) Appl. No.: 12/966,947

(22) Filed: Dec. 13, 2010

(30) Foreign Application Priority Data
Sep. 29, 2010 (TW) 99133066

(51) Int. Cl. G06F 3/041; G09G 5/00

(52) U.S. Cl. 345/173; 345/211

(57) ABSTRACT

A touch input device includes a touch screen, a scan controlling unit and a UI control unit. The UI control unit is configured for identifying one or more effective touch regions according to a user interface displayed on the touch screen, and transmitting a region identifying signal to the scan controlling unit. The scan controlling unit is configured for determining one or more scan regions corresponding to the effective touch regions according to the region identifying signal, and activating a scan over the scan regions. A power saving method for the touch input device is also provided.

### BACKGROUND

1. Technical Field

The present disclosure relates to a touch input device and a power saving method thereof.

2. Description of Related Art

Touch input devices such as capacitive, electromagnetic touch input devices, include plural matrix scanning lines secured in the touch panels of the touch input devices, and analog circuits and digital circuits both connecting to the scanning lines. The whole touch panel is scanned for calculating the touch coordinates to determine the touch location, which consumes a large amount of power.

Therefore, what is needed is a touch input device and a power saving method thereof to alleviate the limitations described above.

### BRIEF DESCRIPTION OF THE DRAWINGS

The components in the drawings are not necessarily drawn to scale, the emphasis instead being placed upon clearly illustrating the principles of a touch input device and a power saving method thereof. Moreover, in the drawings, like reference numerals designate corresponding sections throughout the several views.

FIG. 1 is a schematic diagram of an input interface of a touch input device in accordance with an exemplary embodiment.

FIG. 2 is a block diagram of the touch input device in accordance with the exemplary embodiment.

FIG. 3 is a schematic diagram of an input interface of a touch input device in accordance with another exemplary embodiment.

FIG. 4 is a flowchart of a power saving method for touch input devices, such as the one of FIG. 1, in accordance with the exemplary embodiments.

### DETAILED DESCRIPTION

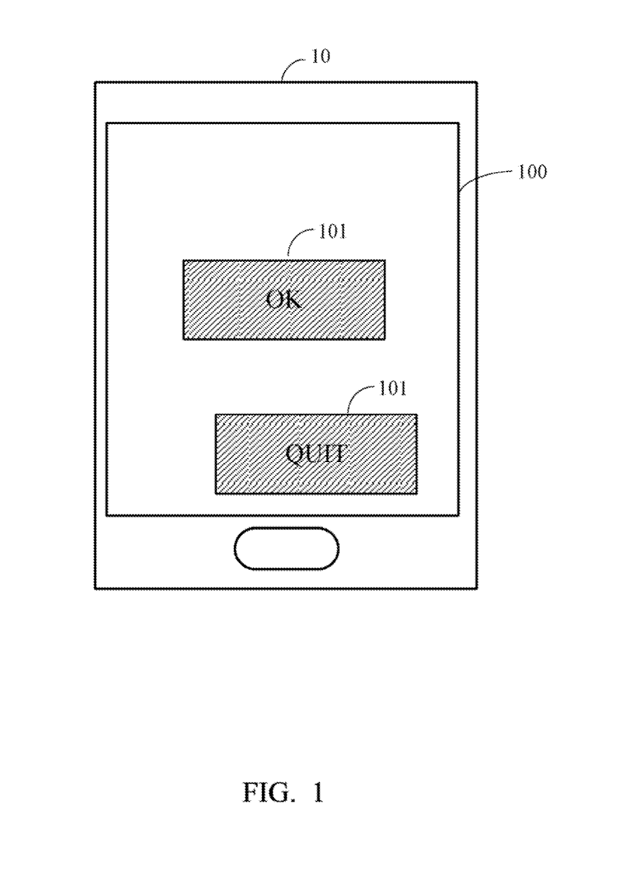

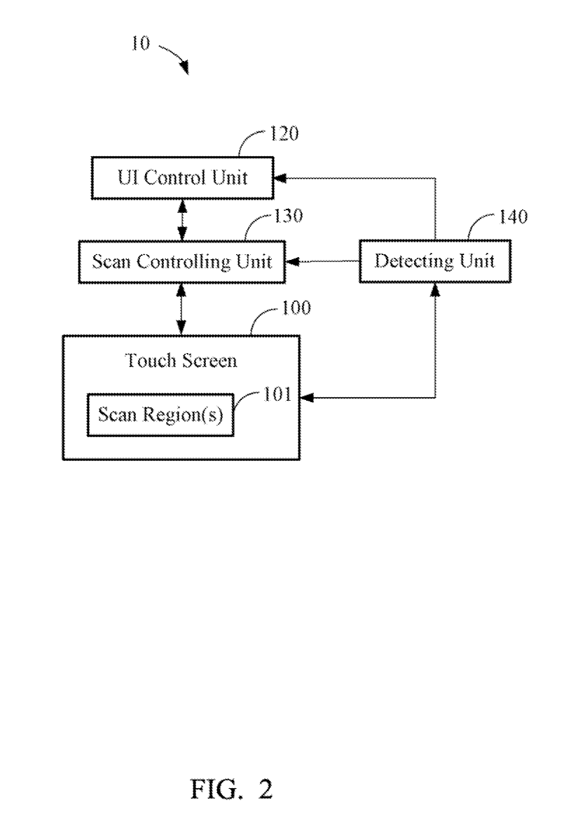

Referring to FIGS. 1 and 2, a touch input device 10 is disclosed as an exemplary embodiment. The touch input device 10 includes a touch screen 100, a UI (User Interface) control unit 120, a scan controlling unit 130 and a detecting unit 140.

The UI control unit 120 is configured for identifying an effective touch region(s) displayed on the touch screen 100, and transmitting region identifying signals to the scan controlling unit 130. The effective touch region here refers to a region on the user interface of the touch screen 100, which is provided for users to touch and operate an electronic device equipped with the touch input device 10. For example, “OK”, “QUIT” buttons displayed on the user interface of the touch screen 100 are the effective touch regions for they are provided for users to confirm or cancel a former operation. The region identifying signals include the number and the locations of the effective touch regions.

The scan controlling unit 130 is configured for receiving the region identifying signals transmitted from the UI control unit 120, and determining one or more scan regions 101 corresponding to the effective touch regions according to the region identifying signals. The scan controlling unit 130 is further configured for activating the intermittent scan over the scan regions 101, here, “intermittent” means the scan is started and stopped at irregular intervals according to the region identifying signals. In the embodiment, a scan region 101 is entirely overlapped with a corresponding effective touch region and has a same size as the corresponding effective region. In other words, a scan region exactly covers a corresponding effective touch region.

The scan controlling unit 130 is further configured for terminating the scan over a scan region 101 when users' input by a corresponding effective touch region is completed. For example, the scan over an “OK” button is terminated when the “OK” button grays out after a user click. Furthermore, the UI control unit 120 is also configured for identifying effective touch regions again when the user interface on the touch screen 100 is changed to another. The scan controlling unit 130 determines scan regions 101 corresponding to the effective touch regions once again, and activating the intermittent scan over those scan regions 101.

FIG. 2 shows an example of a UI on the touch screen 100. In the example, only an “OK” button and a “QUIT” button are provided on the UI for a user to operate. That is, two effective touch regions exist on the UI. The UI control unit 120 identifies the two buttons as the effective touch regions and the scan controlling unit 130 determines two scan regions, each exactly covers a corresponding button. The scan controlling unit 130 alternately activates and deactivates the scan over the scan regions 101 in turn, so as to identify the operations on the buttons.

The rest region of the UI is not provided for the user to operate. Therefore the scan over this region is omitted, thus to save power.

The detecting unit 140 is configured for detecting the touch location on the scan regions 101 and transmitting touch signals to the UI control unit 120. The detecting unit 140 is further configured for detecting whether the input operation of the user on the scan regions is completed and transmitting the detecting results to the scan controlling unit 130.

The UI control unit 120 is further configured for receiving the touch signals and detecting results transmitted from the detecting unit 140, identifying the touch signals and controlling the touch screen 100 to display the results of the touch operation. The UI control unit 120 is also configured for identifying whether the displayed UI on the touch screen 100 is changed to another UI, and transmitting the detecting results to the scan controlling unit 130.

With such a configuration, the scan controlling unit 130 determines the scan regions 101 according to the effective touch regions identified by the UI control unit 120, and only scans one or more particular regions which are actually provided for users to operate. Without the needs of always scanning the whole touch screen 100, power consumption of the touch input device 10 is effectively reduced.

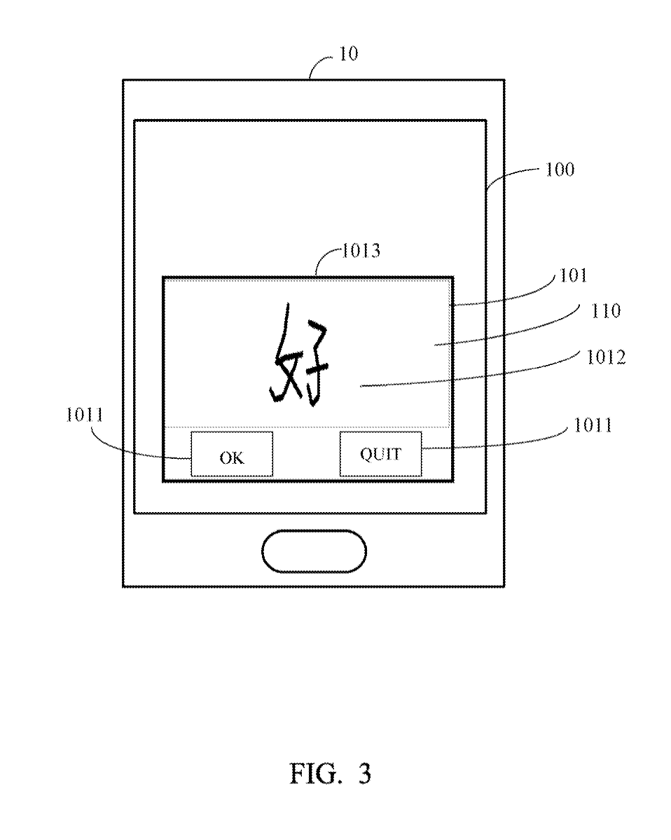

Referring to FIG. 3, a touch input device 10 is disclosed as another exemplary embodiment. The differences between the two embodiments are: the touch screen 100 further includes a handwriting input region 110. Both of the handwriting input region 110 and the regions of the “OK” and “QUIT” buttons are identified as the effective touch regions by the UI control unit 120. To improve the detecting accuracy on the handwriting input region 110 and regions of the “OK” and “QUIT” buttons, the scan controlling unit 130 determines scan regions 101 which include a first scan region 1011, a second scan region 1012 and a third scan region 1013. The first scan region 1011 covers the “OK” and “QUIT” buttons. The second scan region 1012 covers the handwriting input region 110. The third scan region 1013 covers both the first and second scan regions 1011, 1012.

In this embodiment, the scan controlling unit 130 determines the scan regions 101 including the first, second and third scan regions 1011, 1012, 1013, and sequentially activates the scan over the scan regions 101 instead of over the whole touch screen 100. Because the third scan region 1013 covers the first and second scan regions 1011, 1012, the times of scanning over the first and second scan regions 1011, 1012 are doubled. The detecting accuracy on the handwriting input region 110 and regions of the “OK” and “QUIT” buttons are improved. Thus the probability of missing detecting touches on the effective touch regions is reduced. The response speed of the touch screen 100 is effectively improved and the power consumption of the touch input device 10 is also reduced.

In other alternative embodiments, the more numbers of scan regions than that of the effective touch regions are determined according to actual needs, for reducing the probability of lost detection on the effective touch regions. For example, two or more scan regions covering an effective touch region, which is frequently used is also preferred.

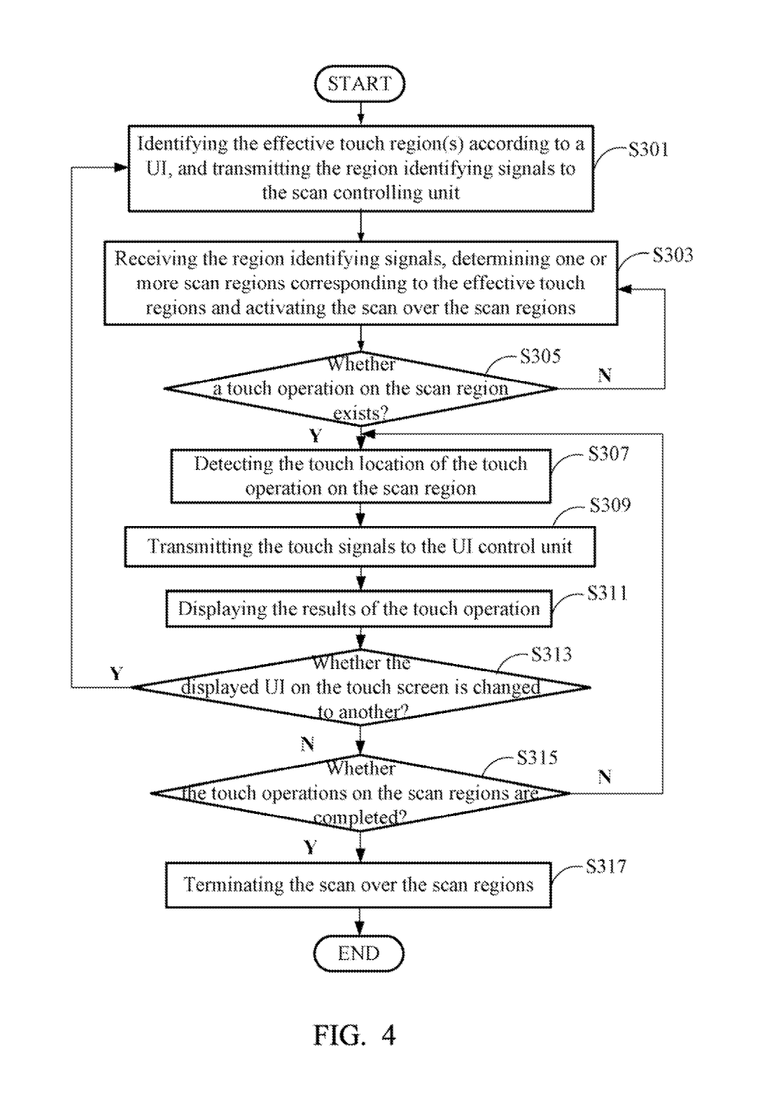

Referring to FIG. 4, a flowchart of a power saving method of the touch input device 10 is shown. The method includes the following steps, each of which is tied to various components contained in the touch input device 10 as shown in FIG. 2.

In step S301, the UI control unit 120 identifies the effective touch region(s) according to a user interface displayed on the touch screen 100, and transmits the region identifying signals to the scan controlling unit 130. The effective touch region here refers to a region on the user interface of the touch screen 100 which are provided for users to touch and operate an electronic device equipped with the touch input device 10. For example, “OK”, “QUIT” buttons displayed on the user interface of the touch screen 100 are the effective touch regions for they are provided for users to confirm or cancel a former operation. The region identifying signals include the number and the locations of the effective touch regions.

In step S303, the scan controlling unit 130 receives the region identifying signals transmitted from the UI control unit 120, and determines one or more scan regions 101 corresponding to the effective touch regions according to the region identifying signals. The scan controlling unit 130 also activates an intermittent scan over the scan regions 101, here, “intermittent” means the scan over a scan region is started and stopped at irregular intervals till the scan over the scan region is finished for the operation on the corresponding effective touch region is completed or the UI is changed to another. In the exemplary embodiment, the scan region 101 may exactly covers one or more corresponding effective touch regions. Two or more scan regions cover an effective touch region which is frequently used are also preferred. The number of the scan regions may be the same or more than that of the effective touch regions.

In step S305, the detecting unit 140 detects whether a touch operation on the scan region 101 exists. If the touch operation on the scan region 101 does not exist, the procedure goes back to step S303.

In step S307, if the touch operation on the scan region 101 exists, The detecting unit 140 detects the touch location of the touch operation on the scan region 101.

In step S309, the detecting unit 140 transmits the touch signals to the UI control unit 120.

In step S311, the UI control unit 120 receives and identifies the touch signals, and controls the touch screen 100 to display the results of the touch operation.

In step S313, the UI control unit 120 identifies whether the displayed UI on the touch screen 100 is changed to another, and transmits the identifying signals to the scan controlling unit 130, if yes, the procedure goes back to step S301; if no, the procedure goes to step S315. In the embodiment, when the displayed UI on the touch screen 100 is changed to another, the UI control unit 120 automatically identifies effective touch regions again. The scan controlling unit 130 determines scan regions 101 corresponding to the effective touch regions once again, and activating the intermittent scan over those scan regions 101.

In step S315, the detecting unit 140 detects whether the touch operations on the scan regions are completed, if yes, the procedure goes to step S317; if no, the procedure goes back to step S307.

In step S317, the scan controlling unit 130 terminates the scan over the scan regions

Although the present disclosure has been specifically described on the basis of the embodiments thereof, the disclosure is not to be construed as being limited thereto.

Various changes or modifications may be made to the embodiments without departing from the scope and spirit of the disclosure.

What is claimed is:

1. A touch input device, comprising:
a touch screen;
a scan controlling unit; and
a UI control unit configured for identifying one or more effective touch regions according to a user interface displayed on the touch screen, and transmitting a region identifying signal to the scan controlling unit;
wherein the scan controlling unit is configured for determining one or more scan regions corresponding to the effective touch regions according to the region identifying signal, and activating a scan over the scan regions.

2. The touch input device as described in claim 1, further comprising a detecting unit configured for detecting touch operations on the scan region.

3. The touch input device as described in claim 2, wherein the detecting unit is further configured for detecting whether a touch operation on one of the scan regions is completed, and the scan controlling unit is further configured for terminating the scan over the scan regions when the touch operation on the scan region is completed.

4. The touch input device as described in claim 2, wherein the UI control unit is further configured for identifying effective touch regions again when the displayed user interface on the touch screen is changed to another user interface, and the scan controlling unit is further configured for determining scan regions once again corresponding to the effective touch regions of the new user interface.

5. The touch input device as described in claim 1, wherein the effective touch regions are regions on the user interface of the touch screen which are provided for users to touch and operate an electronic device equipped with the touch input device, and the region identifying signal comprises the locations of the effective touch regions.

6. The touch input device as described in claim 5, wherein each of the scan regions is overlapped with and has a same size as a corresponding one of the effective regions.

7. The touch input device as described in claim 5, wherein each of the scan regions covers a corresponding one of the effective touch regions.

8. The touch input device as described in claim 5, wherein the touch screen comprises two or more scan regions, and each of scan regions is overlapped with and has a same size as a corresponding one of the effective regions.

9. The touch input device as described in claim 5, wherein the touch screen comprises two or more scan regions, and one of the scan regions covers all the effective touch regions and each of the others of scan regions covers a corresponding one or more of the effective touch regions.

10. The touch input device as described in claim 1, wherein the scan over the scan regions is intermittent.

11. A method power saving method, comprising:
identifying one or more effective touch regions on a user interface;
determining one or more scan regions corresponding to the effective touch regions;
activating a scan over the scan regions;
detecting whether a touch operation on one of the scan regions exists; and
displaying the result of the touch operation when the touch operation on the scan region exists.

12. The method as described in claim 11, further comprising:
detecting whether the user interface is changed to another user interface; and
identifying one or more effective touch regions again when the user interface is changed.

13. The method as described in claim 11, further comprising:
detecting whether the touch operation on the scan region is completed; and
terminating the scan over the scan region when the touch operation on the scan region is completed.

14. The method as described in claim 11, wherein the effective touch regions refer to regions on the user interface of the touch screen which are provided for users to touch and operate an electronic device equipped with the touch input device.

15. The method as described in claim 12, wherein each of the scan regions is overlapped with and has a same size as a corresponding one of the effective regions.

16. The method as described in claim 12, each of the scan regions covers a corresponding one of the effective touch regions.

17. The method as described in claim 12, wherein the touch screen comprises two or more scan regions, and each of the scan regions is overlapped with and has a same size as a corresponding one of the effective regions.

18. The method as described in claim 12, wherein the touch screen comprises two or more scan regions, and one of the scan regions covers all the effective touch regions and each of the others of the scan regions covers a corresponding one or more of the effective touch regions.

19. The method as described in claim 11, wherein the scan over the scan regions is intermittent.
